(19) United States
(12) Patent Application Publication
(10) Pub. No.: US 2015/0106132 A1
(43) Pub. Date: Apr. 16, 2015

(54) PROCESSING INSURANCE PAYMENTS

(71) Applicant: Bank of America Corporation, Charlotte, NC (US)

(72) Inventors: Tyler R. Johnson, Tega Cay, SC (US); Frank Fogliano, Monroe, NY (US); Sara Gill, New York, NY (US)

(73) Assignee: Bank of America Corporation, Charlotte, NC (US)

(21) Appl. No.: 14/054,330

(22) Filed: Oct. 15, 2013

(51) Int. Cl. G06Q 40/08; G06Q 20/10

(52) U.S. Cl. CPC G06Q 40/08; G06Q 20/102
USPC 705/4

(57) ABSTRACT

Methods, systems, computer-readable media, and apparatuses for receiving and processing insurance payments are presented. In some embodiments, an automated teller machine (ATM) may receive an insurance card issued by an insurance provider. Subsequently, the ATM may determine, based on the insurance card, a customer account number and an insurance provider account number. The insurance provider account number may correspond to an insurance provider account associated with the insurance provider, and the customer account number may correspond to a customer account associated with a beneficiary of an insurance plan provided by the insurance provider. The ATM then may accept a deposit, and subsequently the ATM may credit funds associated with the deposit to the customer account.

### BACKGROUND

Aspects of the disclosure relate to computer hardware and software. In particular, one or more aspects of the disclosure generally relate to computer hardware and software for receiving and processing insurance payments.

Millions of individuals lack any form of health insurance coverage, and millions more lack adequate health insurance coverage. There are a number of reasons people might not have insurance, including being unemployed, not being able to afford insurance premiums, being an early retiree, and/or being a child who is no longer a dependent. In addition to millions of people having inadequate or no healthcare, many of these individuals are “unbanked,” meaning that they do not have a bank account. Unbanked individuals often rely on cash or money orders to pay their bills, making it difficult to pay for health insurance when such insurance is otherwise available.

To increase access to health insurance, health care exchanges may be opened to provide a marketplace for individuals to purchase health insurance. These health care exchanges may be supported by large scale insurance providers and may expand the potential customer base for such providers. Although these exchanges and other new healthcare initiatives may increase the ability for insurance providers to serve a greater number of people, new issues may arise as health insurance becomes available to a larger group of people, as unbanked individuals who might otherwise be able to obtain health insurance under these new initiatives may nevertheless encounter difficulties in purchasing and submitting payments for health insurance plans. In particular, it may be difficult for insurance providers to receive payments from unbanked individuals, as these individuals might only be able to make such payments in cash (e.g., because without a bank account, they might not be able to submit insurance payments using checks, credit cards, and/or the like).

### SUMMARY

Aspects of the disclosure provide effective, efficient, and convenient ways of receiving and processing insurance payments. In particular, certain aspects of the disclosure provide techniques for receiving and processing insurance payments at an automated kiosk, such as an automated teller machine (ATM), and may be particularly useful in enabling insurance providers to better serve unbanked individuals.

For example, some aspects of the disclosure provide ways of receiving an insurance payment at an ATM (e.g., by receiving a deposit of funds) and subsequently applying that deposit amount to an insurance plan beneficiary's insurance premium (e.g., by identifying the insurance beneficiary and crediting the payment amount to the insurance beneficiary's customer account). In some instances, the payment funds then may be deposited into an account associated with the insurance provider.

By providing new opportunities for receiving cash payments for health insurance in accordance with one or more aspects of the disclosure, a financial institution or other organization with one or more ATMs may enable unbanked individuals to purchase and pay for health insurance. For instance, by having ATMs accept insurance cards for accessing a customer account associated with an insurance plan, as discussed below, any individual who has health insurance, and thereby an insurance card, will be able to access their customer account and make insurance premium payments at an ATM, even if he or she does not have a bank account.

Thus, in some embodiments discussed below, an ATM may receive an insurance card issued by an insurance provider. Subsequently, the ATM may determine, based on the insurance card, a customer account number and an insurance provider account number. The insurance provider account number may correspond to an insurance provider account associated with the insurance provider, and the customer account number may correspond to a customer account associated with a beneficiary of an insurance plan provided by the insurance provider. Then, the ATM may accept a deposit of funds (e.g., from the current user of the ATM who submitted the insurance card). The ATM may then credit the funds associated with the deposit to the customer account.

In some arrangements, receiving the insurance card may include physically receiving the insurance card in a card input slot of the ATM. In alternative arrangements, receiving the insurance card may include optically scanning a code printed on the insurance card. For example, in optically scanning a code printed on the insurance card, the ATM may scan a barcode, a quick response (QR) code, a two-dimensional barcode, and/or one or more other codes that may encode information. In other arrangements, an ATM may optically scan a code (e.g., a barcode, a quick response (QR) code, a two-dimensional barcode and/or one or more other codes that may encode information) that is printed on an insurance statement generated by the insurance provider for the beneficiary.

In one or more arrangements, before the ATM accepts the deposit, the ATM may determine a balance due for the customer account (e.g., the ATM may access a database maintained by insurance provider to obtain insurance premium balance information for the customer account associated with a beneficiary of an insurance plan provided by the insurance provider) and/or may verify that the insurance card is valid (e.g., the ATM may access a database maintained by insurance provider to obtain information regarding the enrollment status of the customer account associated with a beneficiary of an insurance plan provided by the insurance provider). In some arrangements, after the balance due for the customer account is determined, and the balance due may be displayed on a screen of the ATM.

In some arrangements, after the ATM credits the funds associated with the deposit to the customer account (e.g., by applying the payment amount to any balance due for the customer account), the ATM may deposit the funds into the insurance provider account (e.g., by causing the funds associated with the payment accepted by the ATM to be added to the insurance provider's account) and/or the ATM may provide a receipt indicating that the payment has been processed (e.g., the receipt may include the deposit amount of the payment, an indication that the deposit has been credited to a customer account associated with the beneficiary of the insurance plan and/or any balance on the customer account remaining to be paid).

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A illustrates an example operating environment in which various aspects of the disclosure may be implemented;

FIG. 1B illustrates another example operating environment in which various aspects of the disclosure may be implemented;

FIG. 2 illustrates an example of an automated teller machine for receiving and processing insurance payments according to one or more embodiments;

FIG. 3 illustrates a flowchart that depicts a method of receiving and processing insurance payments according to one or more embodiments;

FIG. 4 illustrates an example of a user interface that may be displayed when a customer approaches an ATM in one or more embodiments;

FIG. 5 illustrates an example of a user interface that may be displayed upon receiving an insurance card in one or more embodiments;

FIG. 6 illustrates an example of a user interface that may be displayed after an ATM accepts a deposit in one or more embodiments; and

FIG. 7 illustrates an example of a user interface that may be displayed after funds are credited to a customer account in one or more embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

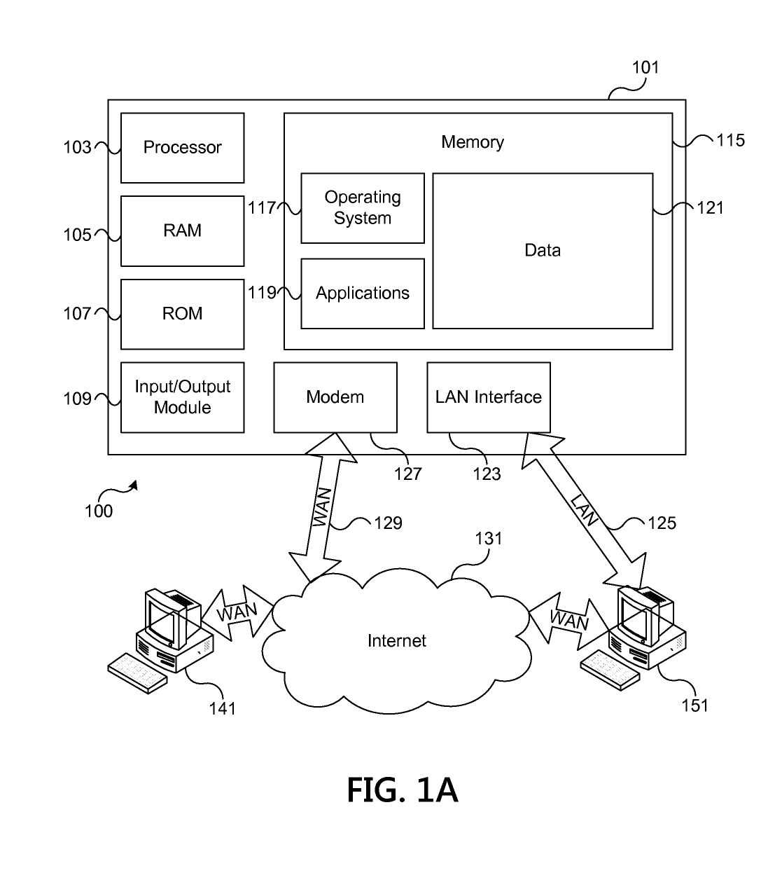

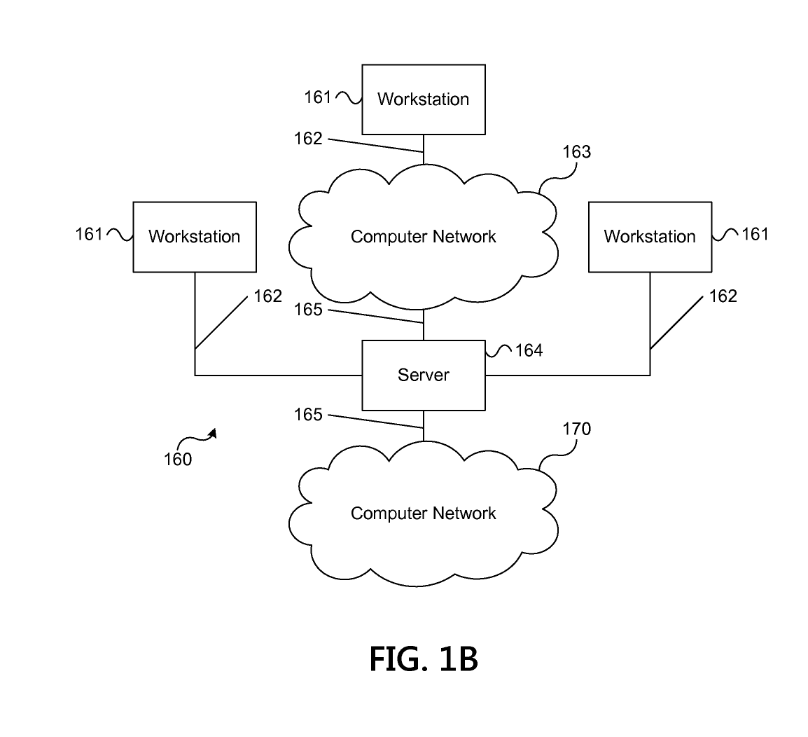

As noted above, certain embodiments are discussed herein that relate to receiving and processing insurance payments. Before discussing these concepts in greater detail, however, an example of a computing device that can be used in implementing various aspects of the disclosure, as well as an example of an operating environment in which various embodiments can be implemented, will first be described with respect to FIGS. 1A and 1B.

FIG. 1A illustrates an example block diagram of a generic computing device 101 (e.g., a computer server) in an example computing environment 100 that may be used according to one or more illustrative embodiments of the disclosure. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

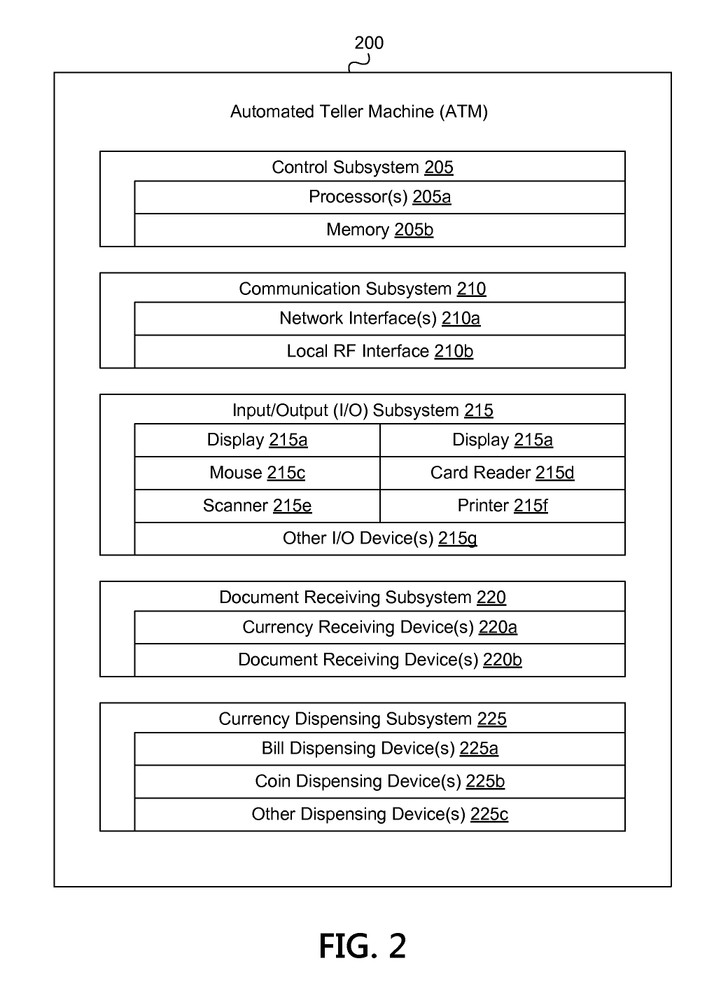

The generic computing device 101 may operate in a networked environment supporting connections to one or more remote computers, such as terminals 141 and 151. The terminals 141 and 151 may be personal computers or servers that include many or all of the elements described above with respect to the generic computing device 101. In some instances, one or more of the terminals 141 and 151 may be automated teller machines, as discussed below with respect to FIG. 2. The network connections depicted in FIG. 1A include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Generic computing device 101 and/or terminals 141 or 151 may also be mobile terminals (e.g., mobile phones, smartphones, PDAs, notebooks, and so on) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 1B illustrates another example operating environment in which various aspects of the disclosure may be implemented. As illustrated, system 160 may include one or more workstations 161. Workstations 161 may, in some examples, be connected by one or more communications links 162 to computer network 163 that may be linked via communications links 165 to server 164. In system 160, server 164 may be any suitable server, processor, computer, or data processing device, or combination of the same. Server 164 may be used to process the instructions received from, and the transactions entered into by, one or more participants.

According to one or more aspects, system 160 may be associated with a financial institution, such as a bank. Various elements may be located within the financial institution and/or may be located remotely from the financial institution. For instance, one or more workstations 161 may be located within a branch office of a financial institution. Such workstations may be used, for example, by customer service representatives, other employees, and/or customers of the financial institution in conducting financial transactions via network 163. Additionally or alternatively, one or more workstations 161 may be located at a user location (e.g., a customer's home or office). Such workstations also may be used, for example, by customers of the financial institution in conducting financial transactions via computer network 163 or computer network 170.

Computer network 163 and computer network 170 may be any suitable computer networks including the Internet, an intranet, a wide-area network (WAN), a local-area network (LAN), a wireless network, a digital subscriber line (DSL) network, a frame relay network, an asynchronous transfer mode network, a virtual private network (VPN), or any combination of any of the same. Communications links 162 and 165 may be any communications links suitable for communicating between workstations 161 and server 164, such as network links, dial-up links, wireless links, hard-wired links, and/or the like.

Having described an example of a computing device that can be used in implementing various aspects of the disclosure and an operating environment in which various aspects of the disclosure can be implemented, several embodiments will now be discussed in greater detail. As introduced above, some aspects of the disclosure generally relate to receiving and processing insurance payments. In the discussion below, various examples illustrating how insurance payments may be received and processed using an ATM in accordance with one or more embodiments will be provided.

FIG. 2 depicts an example of an automated teller machine (ATM) 200 according to one or more illustrative aspects of the disclosure. As indicated above, the ATM 200 may be used for receiving and processing insurance payments in one or more embodiments. As discussed herein, an “automated teller machine,” such as ATM 200, may include and/or incorporate one or more computing devices and/or one or more other components and/or devices that may enable the automated teller machine to receive user input (e.g., from customers of a financial institution), connect to and/or communicate with other devices and/or servers (which may, e.g., include other devices and/or servers that are operated and/or controlled by a financial institution), and/or process transactions (which may, e.g., be requested by users of the automated teller machine and may, for instance, include currency withdrawal transactions, current deposit transactions, check deposit transactions, balance inquiry transactions, and/or other types of transactions). In some instances, the term “automated teller machine,” as used herein, thus may include conventional automated teller machines, as well as other types of similar systems, including automated teller assistants, video teller assistants, and/or other types of currency handling devices.

As seen in FIG. 2, ATM 200 may include various subsystems that may exchange digital information and/or analog electrical signals with each other via wired and/or wireless connections to facilitate operation of the ATM 200 and/or execution of the various functions that the ATM 200 may provide. In one or more arrangements, ATM 200 may include a control subsystem 205, a communication subsystem 210, an input/output (I/O) subsystem 215, a document receiving subsystem 220, and a currency dispensing subsystem 225. While these subsystems are discussed herein as examples of the subsystems that may be included in ATM 200 in some embodiments, the ATM 200 may, in other embodiments, include additional and/or alternative subsystems than those discussed with respect to FIG. 2. For instance, one or more of the example subsystems may be combined and/or replaced by other subsystems that may enable ATM 200 to provide similar, additional, and/or alternative functionalities.

In some embodiments, control subsystem 205 may be configured to monitor, manage, command, and/or otherwise control one or more of the other subsystems included in ATM 200, as well as the overall operations of and/or functionalities provided by the ATM 200. For example, control subsystem 205 may include one or more processors 205a and memory 205b. The one or more processors 205a may, for instance, be configured to receive and/or process information and/or signals received from other subsystems, and may be further configured to send commands, other information, and/or various signals to the other subsystems included in ATM 200. In addition, memory 205b may be configured to store computer-readable instructions and/or other information that may cause the one or more processors 205a to execute various programs and/or that may be otherwise used by the one or more processors 205a.

In some embodiments, communication subsystem 210 may be configured to send, receive, and/or otherwise facilitate communications between ATM 200 and one or more servers and/or other computing devices. For example, communication subsystem 210 may include one or more network interfaces 210a and/or one or more local radiofrequency (RF) interfaces 210b. The one or more network interfaces 210a may, for instance, include one or more wired and/or wireless communications interfaces, such as one or more Ethernet interfaces, one or more IEEE 802.11a/b/g/n interfaces, one or more cellular interfaces (e.g., CDMA interfaces, GSM interfaces, and/or the like), and/or one or more other interfaces. The one or more network interfaces 210a may, for example, enable the ATM 200 to communicate with one or more servers and/or other devices via various networks, which may include local area networks (LANs), wireless local area networks (WLANs), cellular networks, and/or other networks. In addition, the one or more local RF interfaces 210b may, for instance, include one or more short-range wireless communication interfaces, such as one or more near field communications (NFC) interfaces, one or more Bluetooth interfaces, and/or one or more other interfaces. The one or more local RF interfaces 210b may, for instance, enable the ATM 200 to communicate with a local device, such as a mobile computing device used by a user of the ATM 200, that may be within close range of (and/or otherwise within a predetermined distance of) the ATM 200.

In some embodiments, input/output (I/O) subsystem 215 may be configured to receive one or more types of input (e.g., from a user of the ATM 200) and/or provide one or more types of output (e.g., to the user of the ATM 200). For example, I/O subsystem 215 may include a display 215a, a keypad 215b, a mouse 215c, a card reader 215d, an optical scanner 215e, a printer 215f, and/or one or more other I/O devices 215g that each may be configured to receive and/or provide various types of input and/or output. The display 215a may, for instance, be configured to display and/or otherwise provide graphical and/or video output to a user of the ATM 200. In some instances, display 215a may include a touchscreen that may, for instance, be configured to receive input from a user of the ATM 200 via one or more touch-sensitive surfaces. In addition, keypad 215b may, for instance, include one or more buttons that are configured to allow a user of the ATM 200 to provide character input, and mouse 215c may be configured to allow the user to move a cursor and select items included in a user interface. Card reader 215d may, for instance, include one or more receptacles, magnetic stripe readers, chip readers, and/or the like, and may be configured to physically receive and electronically obtain information from a payment card, such as a debit card or credit card. Optical scanner 215e may, for instance, include one or more cameras and may be configured to capture an image and obtain information from items included in the image, such as one or more barcodes and/or quick response (QR) codes. Printer 215f may, for instance, be configured to print one or more receipts and/or other documents that may provide physical output to a user of the ATM 200. Furthermore, one or more other input and/or output devices 215g may receive and/or provide additional and/or alternative types of input and/or output to a user of the ATM 200.

In some embodiments, document receiving subsystem 220 may be configured to receive various types of documents (e.g., from a user of the ATM 200 who may, for instance, be depositing funds and/or otherwise submitting one or more documents for processing by a financial institution operating the ATM 200). For example, document receiving subsystem 220 may include one or more currency receiving devices 220a and/or one or more document receiving devices 220b. The one or more currency receiving devices 220a may, for instance, include one or more slots, rollers, scanners, cartridges, and/or other components that may be configured to physically receive, process, and/or store various types of currency (e.g., coins, bills, and/or other types of currency). In addition, the one or more document receiving devices 220b may, for instance, include one or more slots, rollers, scanners, cartridges, and/or other components that may be configured to physically receive, process, and/or store various types of financial documents (e.g., checks).

In some embodiments, currency receiving subsystem 225 may be configured to dispense various types of currency and/or other items (e.g., to a user of the ATM 200 who may, for instance, be withdrawing funds and/or otherwise obtaining documents and/or other items from the ATM 200). For example, currency dispensing subsystem 225 may include one or more bill dispensing devices 225a, one or more coin dispensing devices 225b, and/or one or more other dispensing devices 225c. The one or more bill dispensing devices 225a may, for instance, include one or more slots, rollers, scanners, cartridges, and/or other components that may be configured to physically dispense one or more bills (e.g., to a user of the ATM 200). The one or more coin dispensing devices 225b may, for instance, include one or more slots, rollers, scanners, cartridges, and/or other components that may be configured to physically dispense one or more coins (e.g., to a user of the ATM 200). Additionally, the one or more other dispensing devices 225c may, for instance, include one or more slots, rollers, scanners, cartridges, and/or other components that may be configured to dispense one or more other items to a user of the ATM 200.

As noted above, while the ATM 200 and the various subsystems and/or other devices discussed above illustrate one or more example arrangements of an automated teller machine in some embodiments, one or more other subsystems and/or devices may be included in an automated teller machine in addition to and/or instead of those discussed above in other embodiments.

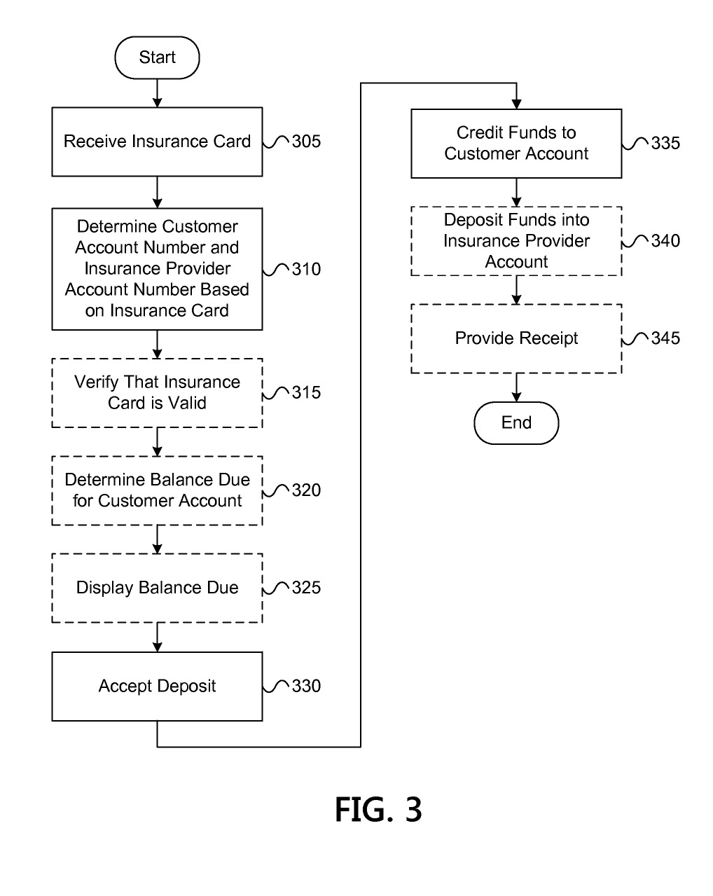

Having described an example ATM that may be used in receiving and processing insurance payments in some embodiments, an example of a method that may, in some embodiments be performed (e.g., by such an ATM 200; by another computing device, such as computing device 101; and/or the like) will now be discussed in greater detail with respect to FIG. 3.

FIG. 3 illustrates a flowchart that depicts a method of receiving and processing insurance payments according to one or more embodiments. In some embodiments, the example method illustrated in FIG. 3 may be performed by an ATM, such as ATM 200. In additional and/or alternative embodiments, the example method illustrated in FIG. 3 may be performed by another type of computing device, such as a computing device that includes and/or implements one or more aspects of computing device 101. In still other embodiments, the example method illustrated in FIG. 3 may be implemented in and/or may otherwise be embodied in computer-readable instructions that may be stored in a computer-readable medium, such as a memory.

As seen in FIG. 3, the method may be initiated in step 305, in which an insurance card may be received by an ATM. For example, in step 305, an ATM may receive an insurance card (e.g., a health insurance card, a vision insurance card, a dental insurance card, or another type of insurance card). In some instances, in receiving the insurance card in step 305, the ATM may physically receive the insurance card in a card input slot of the ATM. In addition, the ATM may scan and/or otherwise obtain information from the insurance card (e.g., by reading information from a magnetic stripe on the card, by obtaining information from a data chip included in the card, and/or by otherwise obtaining stored and/or encoded information from a data source on and/or in the insurance card). In other arrangements, in receiving the insurance card in step 305, the ATM may optically scan the insurance card, for instance, using a camera or other scanner included in and/or coupled to the ATM. In optically scanning the insurance card, the ATM may capture an image of and subsequently analyze any visible source of information on the insurance card (e.g., a code printed on at least one side of the card).

In some arrangements, the insurance card may include insurance information for a beneficiary of an insurance plan (e.g., the name of a beneficiary, the name of the insurance provider, the beneficiary's insurance plan identification number, and the like), and such information may be printed on at least one side of the card. Additionally and/or alternatively, the insurance card may include a visible and/or otherwise scannable source of information, such as a scannable code printed on at least one side of the card (e.g., a barcode, a quick response (QR) code, a two-dimensional barcode, and the like). The information contained in the scannable source of information may include the name of the account holder, the name of the beneficiary of the insurance plan, the customer account number, the name of the insurance provider, the insurance provider account number, and/or other information.

In step 310, a customer account number and an insurance provider account number may be determined based on the received insurance card. For example, in step 310, the ATM may read the insurance card received in step 305 (e.g., by reading information from a magnetic stripe or data chip included in and/or on the card, by extracting information from the visible and/or otherwise scannable source of information included in and/or on the card, and/or the like) and subsequently may determine a customer account number and an insurance provider account number associated with the card. The insurance provider account number may, for example, correspond to an insurance provider account associated with the insurance provider. In addition, the customer account number may, for instance, correspond to a customer account associated with a beneficiary of an insurance plan provided by the insurance provider.

In step 315, the insurance card may be verified. For example, in step 315, the ATM may verify that the insurance card is valid (e.g., by verifying that the customer is enrolled in an insurance plan associated with the insurance card, by verifying that such an insurance plan has not expired, and/or by otherwise verifying that the insurance card is valid). For instance, in verifying the insurance card in step 315, the ATM may access and/or obtain insurance plan information associated with the insurance card from one or more databases and/or other resources that may be maintained by the insurance provider (e.g., rather than being maintained by the financial institution that has deployed the ATM). The obtained insurance plan information may, for instance, include information regarding the enrollment status of an insurance plan associated with an insurance card (such as, for instance, information about the beneficiary of the insurance plan, the insurance plan account number, the initiation date of the insurance plan, the future renewal date of the insurance plan, and/or the current enrollment status of the beneficiary of the insurance plan). In response to receiving the insurance plan information from the database, the ATM may confirm, based on the received insurance plan information, that the insurance card associated with the insurance plan is valid or invalid (e.g., active or inactive).

In step 320, the balance due for a customer account may be determined. For example, in step 320, the ATM may determine the balance due for a customer account (e.g., by identifying the current insurance premium for the insurance plan and determining the remaining balance to be paid). In some arrangements, in determining the balance due for the customer account in step 320, the ATM may access and/or obtain insurance plan information associated with the insurance card from one or more databases and/or other resources maintained by the insurance provider. The insurance plan information may include the beneficiary's enrollment information in the insurance plan (which may, e.g., include the beneficiary's enrollment status, insurance premium value, date of last payment, amount of last payment, total remaining balance, pending invoice amount, and the like). In response to receiving the insurance plan information from the database, the ATM may determine the current balance due for the insurance plan associated with the insurance card.

In step 325, the balance due may be displayed. For example, in step 325, the ATM may display an amount of money that may be owed to the insurance provider by the beneficiary for an insurance payment. For instance, after accessing one or more databases and/or other resources maintained by the insurance provider and determining the balance information for the customer account associated with the insurance card, the ATM may display the balance information on a screen of the ATM. The balance information displayed on the screen of the ATM may be a total remaining balance due for the insurance plan associated with the insurance card. Additionally or alternatively, the balance information displayed on the screen of the ATM may be a currently due insurance premium payment amount.

In step 330, a deposit may be accepted. For example, in step 330, the ATM may physically receive and/or otherwise accept a deposit from a user of the ATM. In some instances, the ATM may receive a monetary deposit (e.g., cash, check, money order, and/or some other form of payment). For instance, the ATM may receive a cash deposit in a cash input slot of the ATM. Additionally or alternatively, the ATM may receive a check deposit in a check input slot of the ATM and/or the ATM may optically scan a check. In other instances, the ATM may receive a money order in an input slot of the ATM and/or the ATM may optically scan a money order. The monetary amount of the deposit may be recorded by the ATM.

In step 335, funds may be credited to a customer account. For example, in step 335, the deposit accepted by the ATM may be credited to the customer account associated with the insurance card. In some instances, the monetary amount of the funds deposited may be applied towards a balance due for the customer account associated with the insurance card. For instance, a deposit amount credited to the customer account may be applied to any remaining balance for the customer account (which may, e.g., allow the ATM user to pay off the full balance owed on the customer account). In other instances, a deposit amount credited to the customer account may be applied to the current balance for the customer account (which may, e.g., allow the ATM user to pay off an outstanding insurance premium invoice statement). In still other instances, a deposit amount credited to the customer account may be applied in excess of the balance due (which may, e.g., allow the ATM user to pay in excess of the remaining balance). The excess amount of the deposit may be refunded to the customer or may be credited towards the customer account (e.g., towards one or more insurance premiums that may be due in the future).

In step 340, funds may be deposited into an insurance provider account. For example in step 340, the funds associated with the deposit may be deposited into the insurance provider account identified by the insurance card. In depositing funds into the insurance provider account, the ATM may, for instance, cause the funds associated with the deposit to be transferred into and/or otherwise credited to the insurance provider account (e.g., by communicating and/or otherwise exchanging information with one or more servers and/or other computing devices operated by the financial institution).

In step 345, a receipt may be provided. For example, in step 345, the ATM may provide a receipt acknowledging the deposit of funds. In some instances, the ATM may print a receipt stating the deposit amount of the payment, acknowledging that the deposit is credited to a customer account associated with the beneficiary of the insurance plan and/or stating the remaining balance to be paid. A receipt may be printed automatically upon the termination of the payment transaction. Alternatively, the receipt may be printed in response to a request for a receipt received by the ATM. In other instances, the ATM may transmit a receipt electronically to a customer. A receipt may be transmitted to a customer via e-mail and/or SMS text messaging.

Subsequently, the method may end. As illustrated in the examples above, however, certain aspects of the receiving and processing of insurance payments may be repeated (e.g., in receiving more than one type of payment form, receiving payment for more than one insurance plan, and/or the like). Additionally or alternatively, the ATM may perform similar steps as those illustrated in FIG. 3 and discussed above in receiving and processing other insurance payments.

In an alternative example, an ATM may receive an insurance statement issued by an insurance provider (e.g., instead of and/or in addition to receiving an insurance card in step 305 of the example method discussed above). For example, in receiving such an insurance statement, the ATM may optically scan a barcode, a quick response (QR) code, and/or a two-dimensional barcode that may be printed on the insurance statement. Subsequently, the ATM may determine a customer account number and an insurance provider account number based on optically scanned code and/or based on other information obtained from the insurance statement. In some instances, after one or more account numbers are determined, the customer account may be verified to determine if the beneficiary is still enrolled in the insurance plan associated with the insurance statement, similar to how such information may be verified in the examples discussed above. Additionally or alternatively, the insurance premium balance and/or the total remaining balance for the insurance plan may be determined and displayed. The ATM may then accept a deposit and the funds associated with the deposit are credited to the customer account associated with the insurance card. The funds associated with the deposit may be deposited into an insurance provider's account. Additionally or alternatively, the ATM may print a receipt summarizing the transaction and/or identifying the remaining insurance premium balance and/or remaining total balance to be paid.

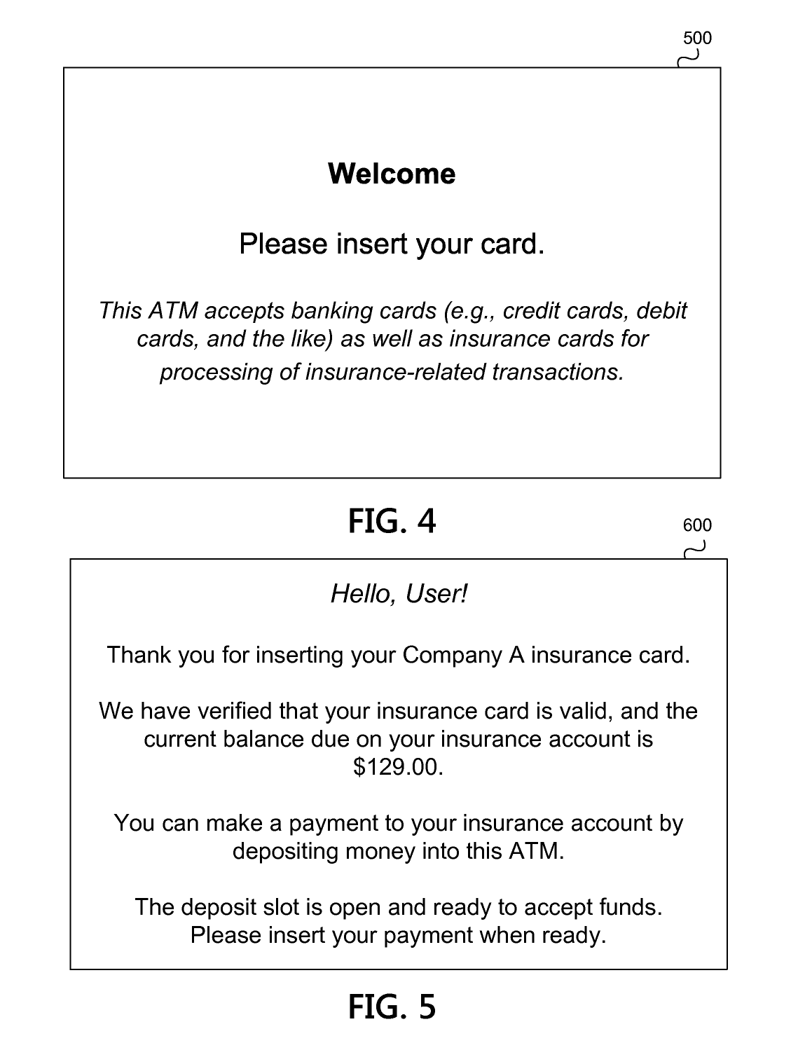

Having described several examples of the processing that may be performed by an ATM in receiving and processing insurance payments in some embodiments, several example user interfaces that might be displayed and/or otherwise provided by a computing device, such as computing device 101 and/or ATM 200, in performing such processing and/or in otherwise receiving and processing insurance payments will now be discussed with respect to FIGS. 4-7.

FIG. 4 illustrates an example of a user interface that may be displayed in providing statements and instructions for receiving and processing insurance payments in one or more embodiments. As seen in FIG. 4, in some instances, a computing device implementing one or more aspects of the disclosure (e.g., computing device 101, ATM 200, and/or the like) may display and/or otherwise provide a user interface 400 that includes a portal in which statements and instructions for the receipt and processing of insurance payments can be displayed.

In some arrangements, user interface 400 may include a welcome screen (which may, e.g., include a welcome message). In particular, the welcome screen may include instructions for initiating a transaction. In some instances, the welcome screen may include information regarding the types of transactions that may be performed by the ATM (which may, e.g., include determining if there is a remaining balance to be paid for the customer account, making a deposit towards a customer account, printing a receipt with balance information for the customer receipt, and the like).

FIG. 5 illustrates another example of a user interface that may be displayed in providing statements and instructions for receiving and processing insurance payments in one or more embodiments. As seen in FIG. 5, in some instances a computing device implementing one or more aspects of the disclosure (e.g., computing device 101, ATM 200 and/or the like) may display and/or otherwise provide a user interface 500 that includes a portal in which statements and instructions for receiving and processing insurance payments can be displayed.

In some arrangements, user interface 500 may include at least one statement in which a user is instructed on using an ATM. For example, a screen may display a personalized welcome message in response to receiving an insurance card. Additionally or alternatively, the screen may display a balance due for a customer account associated with the insurance card (which may, e.g., indicate a current insurance premium balance and/or a total remaining balance) and/or a validity statement regarding the validity of the insurance card and the associated insurance plan (which may, e.g., indicate whether a beneficiary is still enrolled in an insurance plan). Additionally or alternatively, the screen may display instructions on how to proceed with making a payment to a customer account associated with an insurance plan.

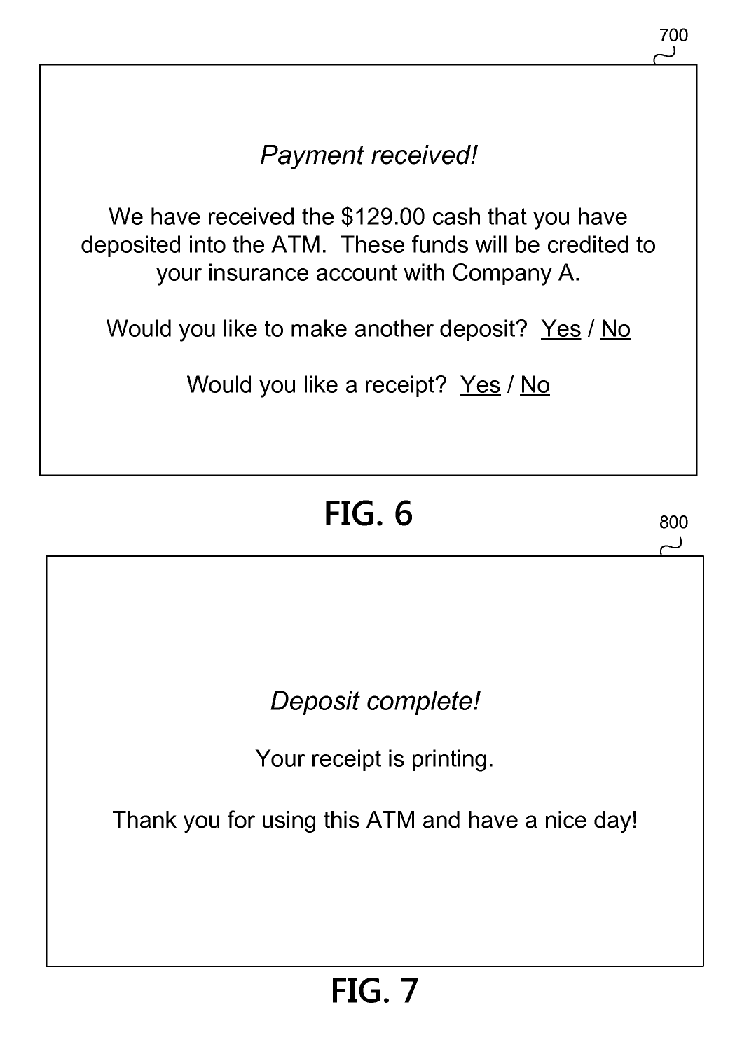

FIG. 6 illustrates another example of a user interface that may be displayed in providing statements and instructions for receiving and processing insurance payments in one or more embodiments. As seen in FIG. 6, in some instances a computing device implementing one or more aspects of the disclosure (e.g., computing device 101, ATM 200 and/or the like) may display and/or otherwise provide a user interface 600 that includes a portal in which statements and instructions for receiving and processing insurance payments can be displayed.

In some arrangements, user interface 600 may include at least one statement in which a user is instructed on using an ATM. For example, in response to receiving a payment, a screen may display a statement acknowledging the credit of the payment to the customer account associated with the insurance card. Additionally or alternatively, the screen may present questions regarding possible additional steps of the transaction (which may, e.g., prompt the user to select whether the user would like to conduct another transaction, whether the user would like a receipt, and the like).

FIG. 7 illustrates another example of a user interface that may be displayed in providing statements and instructions for receiving and processing insurance payments in one or more embodiments. As seen in FIG. 7, in some instances a computing device implementing one or more aspects of the disclosure (e.g., computing device 101, ATM 200 and/or the like) may display and/or otherwise provide a user interface 700 that includes a portal in which statements and instructions for receiving and processing insurance payments can be displayed.

In some arrangements, user interface 700 may include at least one statement regarding the completion of a transaction. For example, a screen may display a statement acknowledging the receipt and credit of a payment to a customer account. Additionally or alternatively, the screen may display a statement in response to a receipt request by a user of the ATM (which may, e.g., indicate that a receipt is printing).

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable memory. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, the steps illustrated in the figures may be performed in other than the recited order, and one or more steps illustrated may be optional in accordance with aspects of the disclosure.

What is claimed is:

1. A method comprising:
receiving, by an automated teller machine (ATM), an insurance card issued by an insurance provider;
determining, by the ATM, based on the insurance card, a customer account number and an insurance provider account number, the insurance provider account number corresponding to an insurance provider account associated with the insurance provider, and the customer account number corresponding to a customer account associated with a beneficiary of an insurance plan provided by the insurance provider;
accepting, by the ATM, a deposit; and
crediting, by the ATM, funds associated with the deposit to the customer account.

2. The method of claim 1, further comprising:
after crediting the funds associated with the deposit to the customer account, depositing, by the ATM, the funds into the insurance provider account.

3. The method of claim 1, further comprising:
after crediting the funds associated with the deposit to the customer account, providing, by the ATM, a receipt indicating that the funds have been credited to the customer account.

4. The method of claim 1, further comprising:
before accepting the deposit, determining, by the ATM, a balance due for the customer account.

5. The method of claim 4, further comprising:
before accepting the deposit, causing, by the ATM, the balance due for the customer account to be displayed.

6. The method of claim 1, further comprising:
before accepting the deposit, verifying, by the ATM, that the insurance card is valid.

7. The method of claim 1, wherein the insurance card is a health insurance card that includes printed health insurance information for the beneficiary of the insurance plan on at least one side of the card.

8. The method of claim 1, wherein receiving the insurance card includes physically receiving the insurance card in a card input slot of the ATM.

9. The method of claim 1, wherein receiving the insurance card includes optically scanning a code printed on the insurance card.

10. The method of claim 9, wherein the code includes at least one of: a barcode, a quick response (QR) code, and a two-dimensional barcode.

11. The method of claim 1, further comprising:
after receiving the insurance card, optically scanning, by the ATM, a code printed on an insurance statement generated by the insurance provider for the beneficiary.

12. An automated teller machine (ATM) comprising:
at least one processor; and
memory storing computer readable instructions that, when executed by the at least one processor, cause the ATM to:
receive an insurance card issued by an insurance provider;
determine, based on the insurance card, a customer account number and an insurance provider account number corresponding to an insurance provider account associated with the insurance provider, and the customer account number corresponding to a customer account associated with a beneficiary of an insurance plan provided by the insurance provider;
accept a deposit; and
credit funds associated with the deposit to the customer account.

13. The ATM of claim 12, wherein the memory stores additional computer readable instructions that, when executed by the least one processor, further cause the ATM to:
after crediting the funds associated with the deposit to the customer account, deposit the funds into the insurance provider account.

14. The ATM of claim 12, wherein the memory stores additional computer readable instructions that, when executed by the least one processor, further cause the ATM to:
after crediting the funds associated with the deposit to the customer account, provide a receipt indicating that the funds have been credited to the customer account.

15. The ATM of claim 12, wherein the memory stores additional computer readable instructions that, when executed by the least one processor, further cause the ATM to:
before accepting the deposit, determine a balance due for the customer account.

16. The ATM of claim 15, wherein the memory stores additional computer readable instructions that, when executed by the at least one processor, further cause the ATM to:
before accepting the deposit, cause the balance due for the customer account to be displayed.

17. The ATM of claim 12, wherein the memory stores additional computer readable instructions that, when executed by the least one processor, further cause the ATM to:
before accepting the deposit, verify that the insurance card is valid.

18. The ATM of claim 12, wherein the insurance card is a health insurance card that includes printed health insurance information for the beneficiary of the insurance plan on at least one side of the card.

19. The ATM of claim 12, wherein receiving the insurance card includes physically receiving the insurance card in a card input slot of the ATM.

20. The ATM of claim 12, wherein receiving the insurance card includes optically scanning a code printed on the insurance card.

21. The ATM of claim 20, wherein the code includes at least one of: a barcode, a quick response (QR) code, and a two-dimensional barcode.

22. The ATM of claim 12, wherein the memory stores additional computer readable instructions that, when executed by the least one processor, further cause the ATM to:
after receiving the insurance card, optically scan a code printed on an insurance statement generated by the insurance provider for the beneficiary.
